(19) United States
(12) Patent Application Publication
(10) Pub. No.: US 2025/0200450 A1
(43) Pub. Date: Jun. 19, 2025

(54) CHECK-IN VERIFICATION

(71) Applicant: Stage Lighting Patents, LLC., Windermere, FL (US)

(72) Inventors: Huntly Gordon Christie, Windermere, FL (US); Oliver Giles Hutchinson, Huddersfield (GB)

(73) Assignee: Stage Lighting Patents, LLC., Windermere, FL (US)

(21) Appl. No.: 18/980,763

(22) Filed: Dec. 13, 2024

Related U.S. Application Data
(60) Provisional application No. 63/610,150, filed on Dec. 14, 2023.

(51) Int. Cl. G06Q 10/02; G06Q 30/0645

(52) U.S. Cl. CPC G06Q 10/02; G06Q 30/0645

(57) ABSTRACT

An example of an apparatus is provided. The apparatus includes a memory storage unit to maintain a database. The database is to store a status indicator and check-in date associated with an asset. The asset is linked to a unique identifier. In addition, the apparatus includes a communications interface to receive the unique identifier and a timestamp. Furthermore, the apparatus includes an administration engine in communication with the database. The administration engine is to compare the timestamp with the check-in date of the asset. Furthermore, the administration engine is to check-in the asset when the timestamp is within a time range based on the check-in date.

### CROSS-REFERENCE TO RELATED APPLICATIONS

This application claims priority to U.S. Provisional Application No. 63/610,150, filed Dec. 14, 2023, which is herein incorporated by reference in its entirety.

### BACKGROUND

Businesses may own assets that are loaned, rented, or leased out for use. The types of assets that may be handled in this manner are not limited and may include a wide variety of assets, such as specialized equipment for stages, tools, sports equipment, etc. The benefits of having another entity own and manage assets are known. For example, the users of the asset may focus on using the asset so that they do not focus on maintaining the asset, especially if only a few of the assets are used at a given time. Furthermore, it allows the usage of an asset to be increased as the user may only use the asset for a small portion of the user's operation.

As assets are received back from a loan period, the asset may be scanned automatically as they enter a storage facility, such as a warehouse or storeroom, upon return. For example, each asset may include an identifier, such as a radio-frequency identification tag, barcode, or other readable identifier. In some examples, the identifier may be read as an asset is moved into a storage facility and automatically checked-in upon scanning of the identifier.

### SUMMARY

In accordance with an aspect of the invention, there is provided an apparatus that includes a memory storage unit to maintain a database. The database stores a status indicator and a check-in date associated with an asset. The asset is linked to a unique identifier. The apparatus further includes a communications interface to receive the unique identifier and a timestamp. In addition, the apparatus includes an administration engine in communication with the database. The administration engine is to compare the timestamp with the check-in date of the asset. The administration engine is to check-in the asset when the timestamp is within a time range based on the check-in date.

The range of times when the asset is to be checked-in may include any time after the check-in date. In other examples, the range may also include any time on the check-in date or after the check-in date. The range may further include any time within a predetermined period before the check-in date to after the check-in date.

The unique identifier may be a radio-frequency identifier.

The apparatus may further include a scanner in communication with the communications interface. The scanner may read the unique identifier. The scanner may be disposed in a staging area where the assets enter and leave a building.

### BRIEF DESCRIPTION OF THE DRAWINGS

Reference will now be made, by way of example only, to the accompanying drawings in which:

FIG. 1 is a block schematic diagram of an example apparatus to process assets loaned, rented, or leased to another party;

FIG. 2 is a block schematic diagram of an example scanning device to detect a unique identifier of an asset;

FIG. 3 is a representation of an example system using the apparatus shown in FIG. 1 and the scanning device shown in FIG. 2 to process assets loaned, rented, or leased to another party;

FIG. 4 is a representation of another example system with an apparatus and a plurality of scanning devices to process assets loaned, rented, or leased to another party;

FIG. 5 is a representation of a building deploying the system shown in FIG. 4 in an example configuration; and

FIG. 6 is a flowchart of an example method of processing assets loaned, rented, or leased to another party.

### DETAILED DESCRIPTION

It is common for assets used for commercial purposes to be owned by a party that is different from the one using the asset. There may be a number of reasons to manage assets in this manner. For example, there may be financial benefits, such as tax benefits. Furthermore, for certain types of assets where continuous use is not common or when the assets are used for a discrete period of times, such as for a specific project, the owner of the asset may achieve better utilization of the asset by providing the asset to multiple parties. Another example of a reason for renting or leasing an asset owned by another party may be due to the expertise of the party owning the asset to maintain the asset. For example, the skill set of a party using the asset may not include the skills for maintaining the assets in a good state of repair.

As an example, stage lighting equipment used for performances, such as plays, concerts or lectures to provide visual enhancements are often owned and managed by a party that is different from the performers. In most cases, the assets are not owned by a venue as different stages may use different equipment to provide specific looks or visuals. Additional effects such as pyrotechnic displays and fog machines may be also used. Some of the equipment used to provide the visual effects may be positioned above the stage to improve the generated effect. For example, a light or laser source may be positioned above the stage so that light may be directed at the stage during a performance from above to achieve an appropriate lighting effect. Furthermore, such equipment may be supported around the stage with various trusses which may be provided by other parties.

As another example, rental sporting equipment may be provided to athletes for use. In this example, a sporting venue such as a golf course, ski resort, or watersport rental shop may offer equipment for use by an athlete or participant. The equipment may include golf clubs, skis, watercrafts and associated personal protective equipment. To protect the assets, the owners or operators of the rental shop tracks each piece of equipment as it leaves the shop and cross references the returning equipment against details, such as when the equipment was checked-out, to determine or confirm the costs of the rental.

In some examples, assets may be automatically checked-in to a storage facility upon return. For example, each asset may include an identifier, such as a radio-frequency identification tag, barcode, or other readable identifier, that is read when the asset moves within range of a scanner. Upon detecting the identifier, the asset may be automatically checked-in. Accordingly, if one or more scanning devices are deployed to cover an area where assets are to pass through upon entering the storage facility, the assets that enter and leave the storage facility may be automatically checked-in without a separate user scan. However, it is to be appreciated by a person of skill with the benefit of this description that the scanners may have a range that extends beyond the target area where assets pass through into or out of the storage facility.

Therefore, if an asset is moved close to the area but not being checked-in, the scanner may accidentally detect the asset and check-in the asset unintentionally. Similarly, if the asset covered by the scanners is a staging area or loading dock of a storage facility, assets on a truck may be moved within range of the scanner if the assets are temporarily unloaded from the truck to move items around the truck. Accordingly, assets may be unintentionally checked-in with this automated system.

An apparatus and method of processing assets that are loaned, rented, or leased to others and an apparatus to carry out the method are provided. The apparatus and method increase the efficiency and accuracy of an automated check-in process by reducing the amount of false check-in scans when an asset is moved within range of a scanner, but not intended to be checked-in. It is to be appreciated by a person of skill that once assets are checked-out pursuant to a loan, rental, or lease agreement, the asset may not immediately leave the vicinity. In the present examples, the apparatus may be used to carry out the check-in process while comparing the present date with the expected date of return. If the asset is not expected to be returned by the date on which the scan detects the identifier of the asset, the asset will not be checked-in.

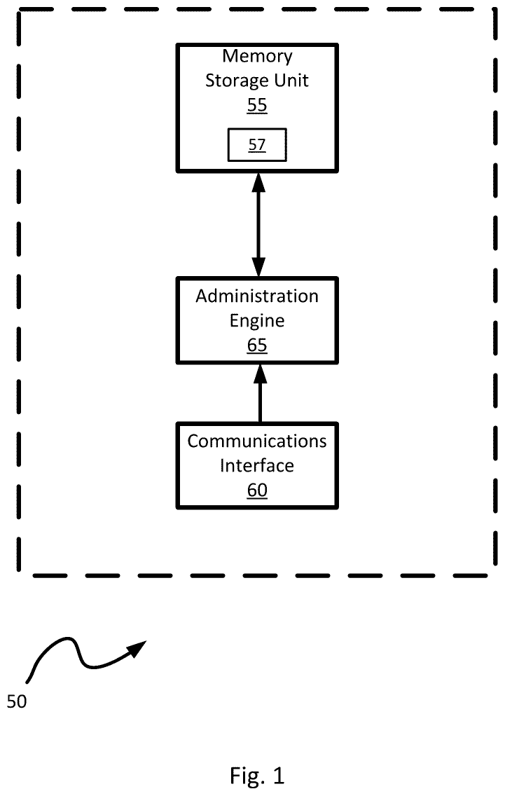

Referring to FIG. 1, an apparatus to process assets loaned, rented, or leased to another party is generally shown at 50. The apparatus 50 may include additional components, such as various devices and interfaces to receive input and output devices to interact with a user or an administrator with access to control the apparatus 50. In the present example, the apparatus 50 includes a memory storage unit 55, a communications interface 60, and an administration engine 65.

The memory storage unit 55 is to maintain a database 57. The information stored in the database 57 is not limited. In the present example, the database 57 is to store records that include a status indicator. For records that indicate that an asset is presently checked-out, the record may also include a field to store a check-in date associated with the asset. Each record in the database 57 may further include a description and specifications linked to each asset, such as a type of asset, a unique identifier of the asset, model number, dimensions, size, etc., to allow the asset to be identified. The status indicator may indicate a status of the asset, such as the location and the condition of the asset. In particular, the status indicator may indicate the asset is checked-out, which means that the asset is currently on loan, rented out or leased out. The status indicator may also indicate that the asset is checked-in, undergoing service or being repaired.

The field to store the check-in date is to store information for an asset that is check-out. In particular, the check-in date is the date when the asset is expected to be returned. For example, the check-in date may be obtained from the rental agreement under which the asset is check-out. In some examples, the apparatus 50 may receive the check-in date from user input or another system configured to manage the assets for rental. In other examples, the check-in date may be automatically populated when an asset is checked-out. It is to be appreciated by a person of skill with the benefit of this description that the check-in date field is used primarily when the asset is check-out to indicate an expected date of return. If the asset is not checked-out, the check-in date field may be unused or used for another purpose, such as an estimated date the asset is expected to return to inventory when the status indicator identifies the asset as being under repair.

In the present example, the memory storage unit 55 is not particularly limited and may include a non-transitory machine-readable storage medium that may be, for example, an electronic, magnetic, optical, or other physical storage device. In the present example, the memory storage unit 55 is a persistent memory that may also store an operating system that is executable by a processor to provide general functionality to the apparatus 50. For example, the operating system may provide functionality to additional applications operating on the apparatus 50. The memory storage unit 55 may additionally store instructions to operate the apparatus 50 to communicate with other components and peripheral devices of the apparatus 50, such as additional reader devices, communication interfaces, display devices, etc. In particular, the instructions may be executed by a processor, which is used to carry out the method of processing assets.

The communications interface 60 is to communicate with a scanning device to receive data that includes a unique identifier and a timestamp associated with the unique identifier. The device from which the data is received may be connected to the communications interface 60 via a network, such as the internet or a local network. Alternatively, the device may be directly connected to the communications interface 60 via a wireless connection such as Bluetooth, WiFi, infrared, or other signals. In further examples, the communications interface 60 may receive data from a hardwired device, such as via a USB connection or a docking station, to download data periodically, such as at the end of the day or after a predetermined period of operation. It is to be appreciated by a person of skill with the benefit of this description that the device and the data received by the communications interface 60 is not particularly limited. In other examples, additional messages may also be received and transmitted from the communications interface 60, such as a status indicator update.

The device used to provide the data to the communications interface 60 is not particularly limited. For example, the device providing the data may be a scanner that is configured to scan and read a unique identifier of an asset. For example, each asset may have an individual unique radio-frequency identification tag disposed on the asset associated with the asset such that the radio-frequency identification tag may operate as an asset identifier. In particular, the radio-frequency identification tag may be affixed or otherwise disposed on the asset to be easily scanned by the device. Accordingly, the scanner may include an antenna to transmit a radio frequency signal to activate a radio-frequency identification (RFID) tag. The RFID tag generates a response signal that may be received and read by the scanner to provide an asset identifier. Once the asset identifier is determined, it may subsequently be transmitted to the apparatus 50 for further processing. In the present example, the scanner may be disposed at a fixed location to cover an area, such as a common area or staging area through which the assets are to pass during the normal course of business, such as during a check-in or check-out process as the assets enter or leave a building, respectively. In other examples, the device may be a smartphone, tablet, laptop, computer terminal device, or a portable electronic device. In other examples, the device may be configured to read another type of identifier, such as a QR code, a serial number, or a barcode.

The timestamp is data that represents the time that the unique identifier was read by the device. The time stored in the timestamp is not particularly limited and may vary from one application to another. In the present example, the timestamp stores a date. In other examples, the timestamp may include more detailed time information, such as the hour, minute, and second. It is to be appreciated by a person of skill with the benefit of this description that in some applications, the exact time an asset is scanned is not very useful to the business. Accordingly, to simplify the data processing to be done by the administration engine 65, less time data may be stored in the timestamp.

The communications interface 60 may also receive data identifying the device that sent the unique identifier and the timestamp. Accordingly, if the device, such as a scanner, is located at a fixed position, the data may be used to identify the area from which the unique identifier was recorded.

The administration engine 65 is in communication with the memory storage unit 55 and configured to manage the database 57 based on data received from the device at the communications interface 60. The administration engine 65 is configured to update or change the status indicator for an asset in the database 57. In the present example, the administration engine 65 is configured to check-in an asset that is scanned by the device. In particular, the administration engine 65 compares the timestamp received at the communications interface 60 with a check-in date in the database 57 associated with the asset that was scanned. In particular, the administration engine 65 compares a timestamp associated with an asset with the check-in date of the asset stored in the database 57. If the timestamp is within a time range of the check-in date, the administration engine 65 changes the status indicator from a checked-out status to a checked-in status.

The specific time range is not particularly limited and may vary from one example to another. In the present example, the time range is based on the check-in date and is to be close to the check-in date while allowing for some variation that may accommodate a late or early check-in of the asset. In one example, the time range may be any time after the check-in date associated with the asset. In further examples, the time range may also include the check-in date itself. Additional examples may allow for the time range to include a predetermined period before the check-in date stored in the database 57 to allow for slightly early returns of the asset.

It is to be appreciated by a person of skill with the benefit of this description that the apparatus 50 provides an accurate automated check-in process of assets being returned to a storage facility. Devices to scan or detect assets may be placed at specific locations to scan unique identifiers associated with the assets. The devices are configured to obtain a unique identifier and a timestamp of when the unique identifier was detected. Upon detecting a unique identifier, the administration engine 65 retrieves the check-in date from the database 57 associated with the unique identifier of the asset. In a case where the timestamp is sufficiently close to the check-in date, the administration engine 65 proceeds to check-in the asset. If the timestamp is not close to the check-in date, or after the check-in date, the asset is not expected to be returned. Accordingly, in this situation, it is assumed the asset was accidentally scanned on a truck passing within proximity of the storage facility, or if the asset were moved temporarily into the storage facility while still in transit.

In the present examples, the apparatus 50 is used to check-in an asset. However, it is to be appreciated by a person of skill with the benefit of this description that the apparatus 50 may have multiple applications where capturing a unique identifier of an asset along with a timestamp may be useful. For example, a scanning device may be placed in a repair facility to update the status of an asset when it is taken out of service for repairs or regular maintenance and returned to service after repairs or regular maintenance. In other examples, apparatus 50 may also be used to track assets that are lost and found.

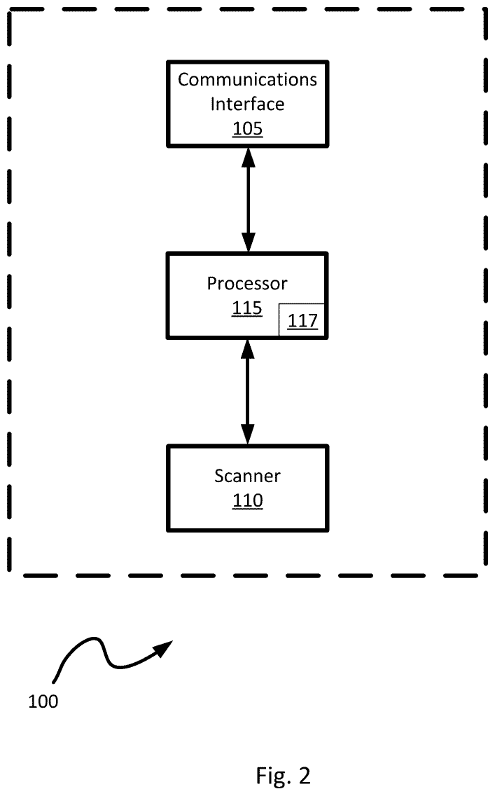

Referring to FIG. 2, a schematic representation of an example of a scanning device 100 to detect a unique identifier of an asset is generally shown. In the present example, the device 100 may be a fixed or portable scanning device. The device 100 is not particularly limited and may include various components, such as interfaces and/or input/output devices such as indicators to interact with a user of the device 100. The interactions may include viewing the operational status, updating parameters, or resetting the device 100. In the present example, the device 100 is to communicate with the apparatus 50. In the present example, the device 100 includes a communications interface 105, a processor 115, and a scanner 110.

The communications interface 105 is to communicate with the apparatus 50. In particular, the communications interface 105 is to transmit data that includes at least a unique identifier associated with an asset. The device 100 may transmit data via a network, such as the internet or a local network. Alternatively, the communications interface 105 may be directly connected to the communications interface 60 of the apparatus 50 via a wireless connection such as Bluetooth, WiFi, infrared, or other signals. It is to be appreciated by a person of skill with the benefit of this description that the data transmitted by the communications interface 105 is not particularly limited. For example, additional data, such as a time stamp or identification information about the device 100 may be transmitted.

The scanner 110 is configured to read a unique identifier of on asset. The manner by which the scanner 110 operates is not particularly limited. For example, the scanner 110 may be operated in a continuous scanning mode such that anything within range will be detected by the scanner 110. Accordingly, the scanner 110 may detect unique identifiers of any asset passing close to the device 100.

The type of scanner 110 is also not particularly limited. In the present example, the scanner 110 may be a radio-frequency antenna to communicate with a radio-frequency identification tag affixed to an asset. Each radio-frequency identification tag may store a radio-frequency identifier to identify the asset. In other examples, the scanner 110 may be an optical scanner to scan a radio-frequency identification tag, barcode, or QR code affixed to the asset.

The processor 115 is to receive the unique identifier obtained by the scanner 110 and to generate a message to be transmitted to the apparatus 50 via the communications interface 105. In the present example, the processor 115 may also maintain a clock 117. The clock 117 may be used to generate a timestamp based on when the unique identifier is read. The timestamp may also be added to the message with the unique identifier to be transmitted to the apparatus 50. It is to be appreciated by a person of skill with the benefit of this description that the unique identifier may be transmitted without a timestamp and that the timestamp may be generated at the apparatus 50.

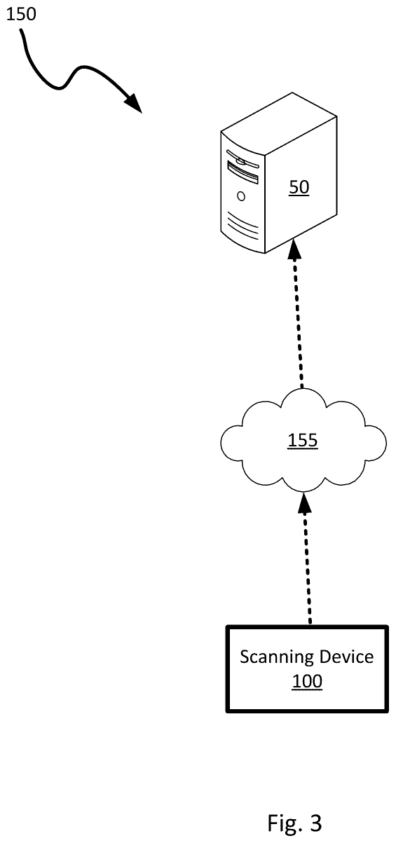

Referring to FIG. 3, an example of a system 150 to process assets loaned, rented, or leased to another party using the apparatus 50 is generally shown. In the present example system 150, the apparatus 50 is in communication with a scanning device 100 via a network 155. It is to be appreciated by a person of skill that the network 155 is not particularly limited and may be any wired or wireless network connecting the apparatus 50 to the scanning device 100. In the present example, the scanning device 100 is to scan an asset for an identifier and to provide the scanned identifier to the apparatus 50 via the network 155. The apparatus 50 subsequently processes the identifiers obtained by the scanning device 100 in a manner described above to determine if the status indicator of the asset associated with each identifier is to be updated or changed.

The scanning device 100 is not particularly limited and may include any device capable of reading an identifier from an asset. The identifier is not particularly limited and may be a radio-frequency identification tag, a barcode or a serial number identifying a specific asset. For example, the scanning device 100 may include a radio-frequency identification reader, a laser scanning device, a camera, a smartphone, or a tablet to read an identifier affixed to the asset. In this example, the scanning device 100 may be an RFID reader device to obtain a unique RFID identifier associated with an asset within range of the scanning device 100.

It is to be appreciated by a person of skill with the benefit of this description that the system 150 is to be used to efficiently scan a plurality of assets to update the status of the assets within range of the scanning device 100. In an example of use of the system 150, assets may be placed in a receiving area or staging area after arriving at the building to be checked-in after the assets are returned from a lender pursuant to a lease agreement. The scanning device 100 scans for unique identifiers in the receiving area or staging area and transmits the scanned identifiers of the assets to the apparatus 50. The apparatus 50 uses the scanned identifier and a timestamp to determine if the status indicator associated with each asset is to be changed from a checked-out status to a checked-in status.

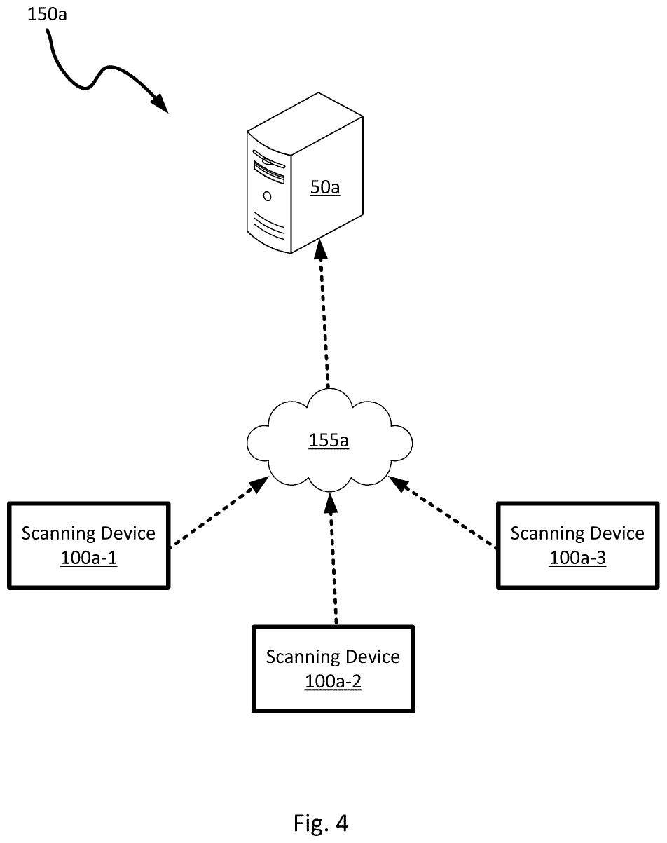

Referring to FIG. 4, another example of a system 150a to process assets loaned, rented, or leased to another party using the apparatus 50a is generally shown. In the present example system 150a, the apparatus 50a is in communication with a scanning devices 100a-1, 100a-2, 100a-3 (generically, these scanning devices are referred to herein as “scanning device 100a” and collectively as “scanning devices 100a”) via a network 155a. It is to be appreciated by a person of skill that the network 155a is not particularly limited and may be any wired or wireless network connecting the apparatus 50a to the scanning devices 100a. In the present example, the scanning devices 100a are to scan for assets with an identifier and to provide the scanned identifier to the apparatus 50a via the network 155a. The apparatus 50a subsequently processes the identifiers obtained by the scanning devices 100a in a manner described above to determine if the status indicator of the asset associated with each identifier is to be updated or changed.

Each scanning device 100a is not particularly limited and may be substantially similar to the scanning device 100. In the present example, the system 150a is to be used to efficiently scan a plurality of assets to update the status of the assets within range of the scanning devices 100a. In an example of use of the system 150a, assets may be placed in one or more receiving areas or staging areas after arriving at the building to be checked-in after the assets are returned from a lender pursuant to a lease agreement. The scanning devices 100a scan for unique identifiers in the receiving areas or staging areas and transmit the scanned identifiers of the assets to the apparatus 50a. The apparatus 50a uses the scanned identifier and a timestamp associated with each identifier to determine if the status indicator associated with each asset is to be changed from a checked-out status to a checked-in status.

It is also to be appreciated by a person of skill with the benefit of this description that although the system 150a includes three scanning devices 100a, the system 150a may be varied to include more or less scanning devices 100a. The multiple scanning devices 100 allow for multiple users to check-in assets at the same time and to transmit the scanned identifiers to the apparatus 50a to update the status indicator for each asset.

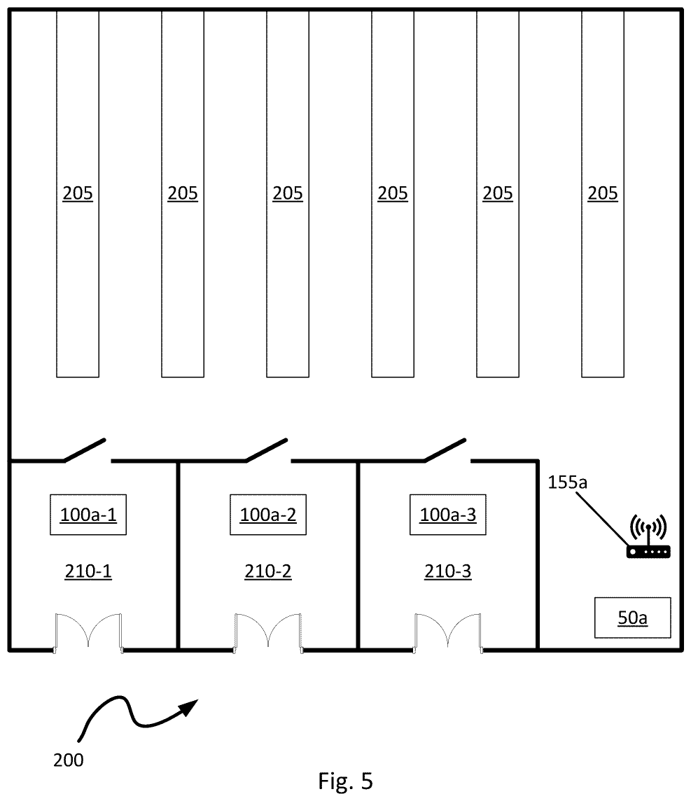

Referring to FIG. 5, an example of the system 150a deployed in a building 200, such as a storage facility, is generally shown. In the present example, the building 200 includes a plurality of storage units 205, and staging areas 210-1, 210-2, 210-3 (generically, these scanning devices are referred to herein as “staging area 210” and collectively as “staging areas 210”). The storage units 205 are to store assets and not particularly limited. Depending on the type of asset to be stored in the storage units 205, the storage unit may include racks, hangers, cabinets, etc.

In each staging area 210, there is a scanning device 100a disposed therein to scan to detect a unique identifier of an asset that is in the staging area 210. In the present example, each staging area 210 is separated by a barrier, such as a wall. In some examples, the scanning device 100a cannot detect identifiers through the wall. Accordingly, the staging area 210 through which an asset passes may be tracked by identifying the scanning device 100a that detected the unique identifier. For example, the scanning device 100a-2 may detect assets in the staging area 210-2 while not being able to detect assets in the staging areal 210-1 or the staging areal 210-3. In some examples, identifying the staging area 210 through which an asset enters the building 200 may be useful for tracking the movement of the assets through the building.

It is also to be appreciated by a person of skill with the benefit of this description that the only manner by which an asset can be checked-in and enter the building 200 is via one of the staging areas 210. Accordingly, any asset that is to be returned to a facility is to pass through the staging area and processed by the system 150a.

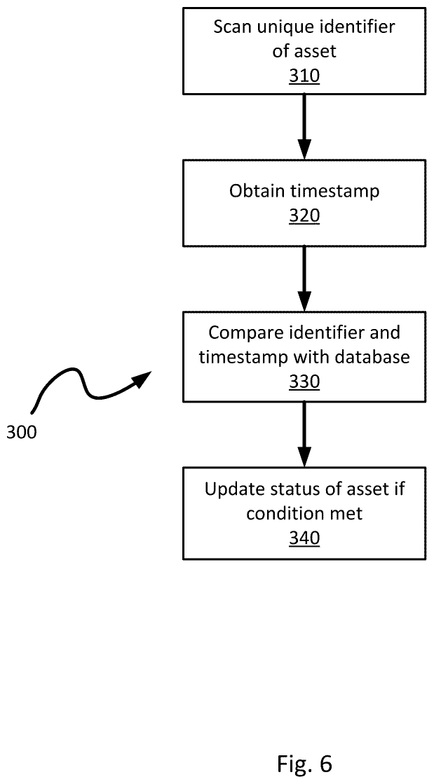

Referring to FIG. 6, a flowchart of a method of processing assets loaned, rented, or leased to another party is generally shown at 300. In order to assist in the explanation of method 300, it will be assumed that method 300 may be performed with the apparatus 50. Indeed, the method 300 may be one way in which the apparatus 50 may be configured. Furthermore, the following discussion of method 300 may lead to a further understanding of the apparatus 50 and its various components. It is to be emphasized, that method 300 may not be performed in the exact sequence as shown, and various blocks may be performed in parallel rather than in sequence, or in a different sequence altogether.

Block 310 involves scanning a unique identifier of an asset. The type of identifier and the manner by which it is scanned is not particularly limited. At block 320, timestamp associated with the unique identifier is obtained. It is to be appreciated by a person of skill that the manner by which the timestamp is obtained is not limited. For example, the timestamp may be generated by a scanning device as the unique identifier is detected. In other examples, the timestamp may be generated upon receiving the unique identifier at a central server where the database 57 is maintained. The timestamp is compared with a check-in date stored in the database 57 at block 330 and the status of the asset is to be updated in the database 57 at block 340 based on the results of the comparison at block 330 and whether a predefined condition is met.

Various advantages will now become apparent to a person of skill with the benefit of this description. In particular, the apparatus 50 and the device 100 provide a fast and efficient way to check-in assets upon return to a storage facility while reducing the number of false check-ins if an asset is prematurely placed within the range of a scanning device 100. This provides an accurate check-in process that may be automated.

It should be recognized that features and aspects of the various examples provided above may be combined into further examples that also fall within the scope of the present disclosure.

What is claimed is:

1. An apparatus comprising:
a memory storage unit to maintain a database, wherein the database is to store a status indicator and check-in date associated with an asset, wherein the asset is linked to a unique identifier;
a communications interface to receive the unique identifier and a timestamp; and
an administration engine in communication with the database, wherein the administration engine is to compare the timestamp with the check-in date of the asset, and wherein the administration engine is to check-in the asset when the timestamp is within a time range based on the check-in date.

2. The apparatus of claim 1, wherein the range includes any time after the check-in date.

3. The apparatus of claim 1, wherein the range includes any time on the check-in date or after the check-in date.

4. The apparatus of claim 1, wherein the range includes any time within a predetermined period before the check-in date to after the check-in date.

5. The apparatus of claim 1, wherein the unique identifier is a radio-frequency identifier.

6. The apparatus of claim 1, further including a scanner in communication with the communications interface, wherein the scanner is to read the unique identifier.

7. The apparatus of claim 6, wherein the scanner is disposed in a staging area, wherein the assets enter and leave a building via the staging area.

8. A method comprising:
scanning for a unique identifier from an asset;
associating the unique identifier with a timestamp;
comparing the unique identifier and the timestamp with a check-in date stored in a database, wherein the check-in date is associated with the asset; and
updating a status indicator associated with the asset based from a checked-out status to a checked-in status when the timestamp is within a time range based on the check-in date.

9. The method of claim 8, wherein the range includes any time after the check-in date.

10. The method of claim 8, wherein the range includes any time on the check-in date or after the check-in date.

11. The method of claim 8, wherein the range includes any time within a predetermined period before the check-in date to after the check-in date.

12. The method of claim 8, wherein scanning for a unique identifier comprises transmitting radio frequency signals to activate a RFID tag and receiving a response signal from the RFID tag, wherein the response signal includes the unique identifier.

13. The method of claim 8, further comprising disposing a scanner in a staging area to scan the assets entering and leaving a building via the staging area.

14. A non-transitory machine-readable storage medium encoded with instructions executable by a processor, wherein the instructions are to direct the processor to:
receive a unique identifier from an asset;
associate the unique identifier with a timestamp;
compare the unique identifier and the timestamp with a check-in date stored in a database, wherein the check-in date is associated with the asset; and
update a status indicator associated with the asset based from a checked-out status to a checked-in status when the timestamp is within a time range based on the check-in date.

15. The non-transitory machine-readable storage medium of claim 14, wherein the instructions direct the processor to update a status indicator when the range includes any time after the check-in date.

16. The non-transitory machine-readable storage medium of claim 14, wherein the instructions direct the processor to update a status indicator when the range includes any time on the check-in date or after the check-in date.

17. The non-transitory machine-readable storage medium of claim 14, wherein the instructions direct the processor to update a status indicator when the range includes any time within a predetermined period before the check-in date to after the check-in date.

18. The non-transitory machine-readable storage medium of claim 14, wherein the instructions direct the processor to operate a scanner.

19. The non-transitory machine-readable storage medium of claim 18, wherein the instructions direct the processor to transmitting radio frequency signals via the scanner to activate a RFID tag and to receive a response signal from the RFID tag, wherein the response signal includes the unique identifier.

20. The non-transitory machine-readable storage medium of claim 19. wherein the instructions direct the processor to scan a staging area. wherein the assets enter and leave a building via the staging area.
